(19) United States
(12) Patent Application Publication
(10) Pub. No.: US 2023/0088558 A1
(43) Pub. Date: Mar. 23, 2023

(54) Fire-Resistant Battery

(71) Applicant: The Trustees of Boston College, Chestnut Hill, MA (US)

(72) Inventors: Dunwei Wang, Newton, MA (US); Haochuan Zhang, Brighton, MA (US); Jingru Luo, San Jose, CA (US)

(73) Assignee: The Trustees of Boston College, Chestnut Hill, MA (US)

(21) Appl. No.: 17/932,807

(22) Filed: Sep. 16, 2022

Related U.S. Application Data
(60) Provisional application No. 63/245,309, filed on Sep. 17, 2021.

(51) Int. Cl. H01M 50/143; H01M 10/0525; H01M 4/134; H01M 4/136; H01M 10/44; H01M 10/058

(52) U.S. Cl. CPC H01M 50/143; H01M 10/0525; H01M 4/134; H01M 4/136; H01M 10/44; H01M 10/058

(57) ABSTRACT

The present invention provides a method of making fire-resistant battery cells comprising nonflammable electrolytes, and use thereof.

### CROSS-REFERENCES TO RELATED APPLICATIONS

This application claims priority to U.S. Provisional Application No. 63/245,309, filed Sep. 17, 2021, the entire contents of the application is incorporated herein by reference.

### STATEMENT REGARDING FEDERALLY SPONSORED RESEARCH OR DEVELOPMENT

This invention was made with government support under CBET1804085 awarded by the National Science Foundation (NSF). The government has certain rights in the invention.

### BACKGROUND OF THE INVENTION

Safety is of paramount importance to modern electrochemical energy storage devices (1, 2). For state-of-the-art Li-ion batteries, a common failure mechanism is understood to start with uneven plating of Li on the anode, leading to the formation of dendrites that would eventually short the circuit (3-6). The flammable nature of the common electrolytes exacerbates the problem and, hence, the often-dramatic fashion in which batteries fail. The problem of uncontrolled Li platting is especially acute for high capacity electrodes such as Li metal (7). This is because the reactions between Li metal and the commonly used carbonate-based electrolytes do not produce stable solid-electrolyte interphase layers (SEI) that are critical to safe battery operations (8-10). How to enable the utilization of Li metal, which features low electrochemical potential and unparalleled capacity, as a direct anode material constitutes a grand challenge in today's intense research on battery technologies (11-13). Inspired by how SEI enables graphite as a successful anode for Li-ion batteries, researchers have tested a number of approaches on forming a similar SEI on Li metal. For instance, fluoroethylene carbonate (FEC) and LiNO₃ have proven effective as additives in introducing LiF-rich and Li₃N/LiNₓO_{y}-rich SEI, respectively, for stable Li operations (14-16). A coating of reactive polymer composites has been shown to enable the formation of self-repairing SEI for high-efficiency cycling in lean electrolyte conditions (17). These exciting progresses notwithstanding, prior demonstrations were carried out in electrolytes that are flammable. The safety concerns connected to the flammability of the electrolyte remain outstanding. Therefore, there is a need for high capacity chargeable battery with nonflammable electrolytes. The present invention provides methods of making and systems of using the same.

### SUMMARY OF THE INVENTION

In one aspect, the present invention provides a battery cell, comprising an anode, a cathode, a nonflammable electrolyte, a separator configured to separate the anode and the cathode and permit lithium ion permeability there-through, and a solid-electrolyte interphase (SEI) layer on the surface of the anode or the cathode. In some embodiments, the battery cell is fire-resistant.

In some embodiments, the anode comprises lithium. In some embodiments, the cathode comprises LiFePO4 (LFP).

In some embodiments, the nonflammable electrolyte comprises triethyl phosphate (TEP).

In some embodiments, the SEI layer comprises Li₃PO₄.

In some embodiments, the SEI layer comprises poly-phosphate.

In some embodiments, the SEI layer comprises Li₃PO₄ and poly-phosphate.

In some embodiments, the SEI layer is formed by exposing the battery cell to O₂.

In some embodiments, the battery cell is purged with O₂.

In some embodiments, the continuous exposure to O₂ is not required for making the safe high capacity battery described herein.

In some embodiments, the SEI layer is formed by electrochemical reduction reaction.

In some embodiments, the thickness of the SEI layer is in a range of about 0.05 μm to about 50 μm.

In some embodiments, the SEI layer is formed during a battery cell charge cycle.

In some embodiments, the SEI layer is stable.

In some embodiments, the lithium stripping and plating is reversible.

In some embodiments, the battery cell has Coulombic Efficiency (CE) selected from the group consisting of 95%, 95.1%, 95.2%, 95.3%, 95.4%, 95.5%, 95.6%, 95.7%, 95.8%, 95.9%, 96%, 96.1%, 96.2%, 96.3%, 96.4%, 96.5%, 96.6%, 96.7%, 96.8%, 96.9%, 97%, 97.1%, 97.2%, 97.3%, 97.4%, 97.5%, 97.6%, 97.7%, 97.8%, 97.9%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8%, 99.9%, and 100%.

In some embodiments, the battery cell has higher Coulombic Efficiency (CE) than the corresponding battery cell without exposing to O₂.

In some embodiments, the SEI layer enhances lithium stripping and plating.

In some embodiments, the battery cell is capable of achieving at least 5,000 charging and discharging cycles with at least 70% capacity retention.

In some embodiments, the battery cell has higher number of charging and discharging cycles with at least 70% capacity retention than the corresponding battery cell without exposing to O₂

In another aspect, the present invention provides a method of making a safe high capacity battery cell comprising a step of exposing the battery cell to O₂.

### BRIEF DESCRIPTION OF THE DRAWINGS

The foregoing summary, as well as the following detailed description of the invention, will be better understood when read in conjunction with the appended drawings.

FIG. 1 illustrates electrochemical performance of TEP electrolyte with or without O₂. cyclic voltammetry (CV) study of Li∥Cu cell with a scan rate of 0.4 mV/s in (a) first cycle and (b) fifth cycle; (c) Voltage profiles of Li∥Li cell for long-term cycling test at a current density of 0.5 mA·cm⁻² with 0.5 mA·h capacity (forming cycle at a current density of 0.1 mA·cm⁻² with 1 mA·h capacity).

FIG. 2 illustrates morphology of deposited Li on Cu electrode surface. SEM images of plated electrodes (a) (b) with O₂ and (c) (d) without O₂ in the cell (scale bar: 5 μm).

FIG. 3 illustrates the possible reaction mechanisms: (a) schematic of possible chemical/electrochemical reactions; (b) proposed reaction pathways toward the formation of Li₃PO₄/poly-phosphate.

FIG. 4 illustrates (a) the relative free energy G^{rel} scheme for the hypothetical Pathway I computed by the M06-2X functional; (b) NMR spectra of electrolyte solutions after cycling; and c) IR spectra of deposited Li on Cu electrode surface.

FIG. 5 illustrates (a) CV measured on a glassy carbon working electrode with or without O₂; (b) Charge-discharge profile of the 3DOm carbon electrode during cycling under constant current (100 mA/gcarbon) with a cutoff capacity of 500 mAh/gcarbon; (c) Charge-discharge profile of Li∥LFP cells with or without O₂ at a current density of 0.2 C; (d) Cycling performance of Li∥LFP cells with or without O₂ at a current density of 0.2 C.

FIG. 6 illustrates CV study of 1M LiTFSI in DME electrolyte (a) with O₂ and (b) without O₂ (tested in Li∥Cu cell with a scan rate of 0.4 mV/s.

FIG. 7 illustrates CV study of 1M LiCl₄ in TEP electrolyte (a) with O₂ and (b) without O₂ (tested in Li∥Cu cell with a scan rate of 0.4 mV/s).

FIG. 8 illustrates voltage profiles of Li∥Cu cell for coulombic efficiency measurement. 2 mA·h capacity Li was first deposited on the Cu at a current density of 0.1 mA·cm⁻² and the cell was then cycled at a current density of 0.2 mA·cm⁻² with 0.4 mA·h capacity for 39 cycles. All Li was stripped finally to calculate average coulombic efficiency.

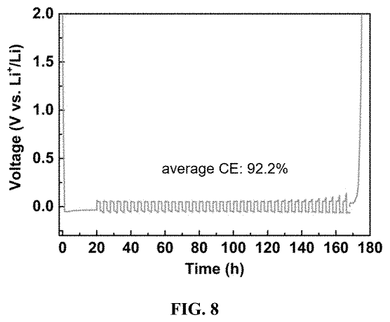

FIG. 9 illustrates morphology of left SEI layer on Cu electrode surface (a) (b) without O₂ and (c) (d) with O₂. Li was first plated on the Cu electrode and then completely stripped out for SEM characterization (scale bar: 5 μm).

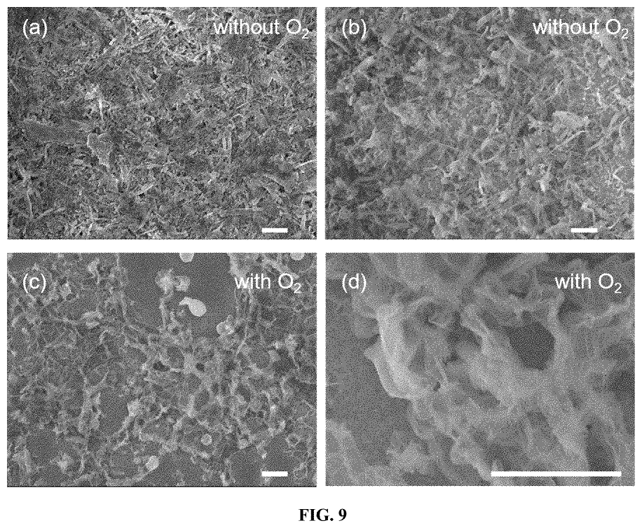

FIG. 10 illustrates XPS spectra of F 1s and P 2p on the Li deposited Cu electrode surface (a) (b) with O₂ and (c) (d) without O₂.

FIG. 11 illustrates voltage profiles of Li∥Li cell for long-term cycling test at a current density of 0.5 mA·cm⁻² with 0.5 mA·h capacity (a) in 1M LiCl₄ in TEP electrolyte and (b) in 1M LiTFSI in TEGDME electrolyte.

FIG. 12 illustrates XPS O 1s spectra of (a) Li foil treated in dry O₂ atmosphere and (b) Li foil cycled in 1M LiTFSI in TEGDME electrolyte.

FIG. 13 illustrates voltage profiles of Li∥Li cell for long-term cycling test at a current density of 0.2 mA·cm⁻² with 0.4 mA−h capacity in TEP electrolyte (a) with Li foil pre-treated in dry O₂ atmosphere and (b) with Li foil pre-cycled in 1M LiTFSI in TEGDME electrolyte.

FIG. 14 illustrates proposed reaction Pathway I between reactive O₂ species and TEP.

FIG. 15 illustrates proposed reaction Pathway II between reactive O₂ species and TEP.

FIG. 16 illustrates the relative free energy G^{rel} (in kcal mol⁻¹) for the hypothetical Pathway II computed by the M06-2X functional.

FIG. 17 illustrates the computed 1H-NMR shift of CH₃CH₂OLi with respect to TMS in ppm by the M06-2X functional with respect to TMS at the same level of theory.

FIG. 18 illustrates EIS of Li∥Li cells before and after cycling (a) without O₂ and (b) with O₂ .

FIG. 19 illustrates (a) SEM image of discharged products on cathode; (b) Raman spectra of discharged products on cathode.

### DETAILED DESCRIPTION OF THE INVENTION

While preferred embodiments of the invention are shown and described herein, such embodiments are provided by way of example only and are not intended to otherwise limit the scope of the invention. Various alternatives to the described embodiments of the invention may be employed in practicing the invention.

Unless defined otherwise, all technical and scientific terms used herein have the same meaning as is commonly understood by one of skill in the art to which this invention belongs.

The use of the terms “a” and “an” and “the” and similar referents in the context of describing the invention (especially in the context of the following claims) are to be construed to cover both the singular and the plural.

Use of the term “about” when referring to a number or a numerical range means that the number or numerical range referred to is an approximation within experimental variability (or within statistical experimental error), and thus the number or numerical range may vary from, for example, between 1% and 15% of the stated number or numerical range. The term “comprising” (and related terms such as “comprise” or “comprises” or “having” or “including”) includes those embodiments such as, for example, an embodiment of any composition of matter, method or process that “consist of” or “consist essentially of” the described features.

Great attention has already been attracted to replicate stable SEI formation on Li anode in nonflammable electrolytes (18, 19). With all other parameters equal, being able to replace flammable electrolytes with nonflammable ones should readily improve the safety of batteries. Guided by this idea, a number of solvents have been tested, and organic phosphates (e.g., triethyl phosphate or TEP) stand out (20, 21). This is because the P atoms can act as trapping agents for hydrogen radicals that play critical roles in initiating combustion chain reactions (20). Prior studies have shown that TEP could serve as a flame retardant to reduce the flammability of conventional electrolytes. Direct utilization of TEP for Li-ion batteries, however, exhibited a multitude of problems, including speculated TEP insertion into graphite and rapidly increasing interface resistance on Li metal (22, 23). To circumvent these issues, approaches such as adding nitrate salts or relying on the decomposition of salts but not solvents have been proposed and proven promising (24-27).

The present invention provides a radically new approach. The strategy involves promoting new chemical reaction pathways. It takes advantage of the unique reactivity between electrochemically reduced O₂ species and TEP, which enables the formation of a stable and effective SEI directly on Li anode. The reaction mechanism is supported by density functional theory (DFT) calculations, which are corroborated by the detection of corresponding products both in the electrolyte and in the SEI. When tested in a symmetric Li∥Li cell, >300 cycles of repeated Li stripping and plating was achieved at a current density of 0.5 mA·cm⁻²; when tested in a Li—O₂ prototypical cell, the system showed comparable performance as in a flammable, ether-based electrolyte. A similar strategy worked equally well for prototypical Li-ion batteries. The approach represents a new direction in addressing the critical safety concerns for high-capacity electrochemical energy storage technologies.

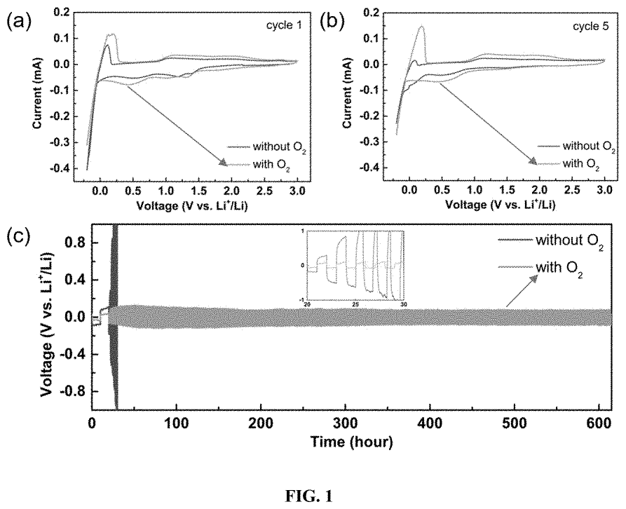

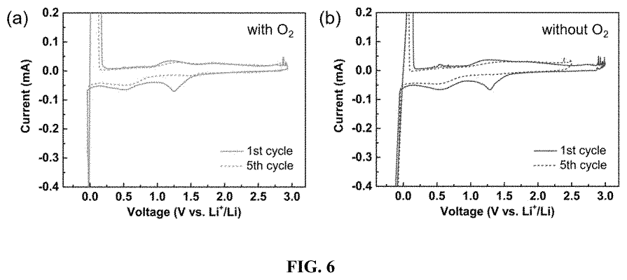

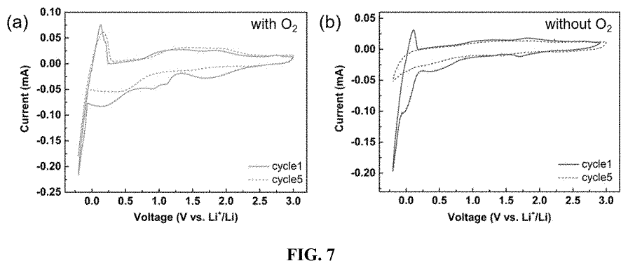

The first task was to establish a baseline of TEP electrochemical behaviors when Li is used as an electrode. For this purpose, 1M Li bis(trifluoromethanesulfonyl)imide (LiTFSI) in TEP as an electrolyte was prepared and a two-electrode Li∥Cu cell that is typically used in the literature for similar studies was constructed. In this configuration, Cu served as the working electrode, and Li was used as both the counter and reference electrodes. As shown in FIG. 1a, three reduction peaks were observed at ca. 1.4 V, 1.2 V and 0.5 V (vs. Li⁺/Li, unless noted, all potentials hereafter are relative to this reference) in the first cycle of cyclic voltammetry (CV) scan. Of them, the peak at 1.2 V was ascribed to the reduction of TEP (20); the peaks at 1.4 V and 0.5 V may report on the reduction of TEP or TFSI⁻ (FIGS. 6-7). The dominating reduction wave past 0 V is due to Li plating onto the Cu working electrode. On the reverse scan, an oxidation peak at ca. 0.1 V was observed, corresponding to the stripping of the newly plated Li. The broad peak at >1.0 V is believed to be due to re-oxidation of SEI components (28). Notably, these redox features were quickly suppressed upon repeated CV scans, and they were barely visible after 5 cycles (FIG. 1b). This feature suggests that the Li stripping/plating in TEP-based electrolyte as observed in the initial CV scan is highly irreversible. Correspondingly, when tested in a symmetric cell, the system exhibited a rapid increase of the stripping and plating overpotentials (FIG. 1c). By the 5th cycle, the plating overpotential already reached −0.75 V, and stripping overpotential reached 1 V. At this point, the test cell was considered as a failure. The phenomenon as reported here is consistent with prior reports on TEP electrochemical behaviors when used directly for Li stripping and plating studies (25, 26). It highlights the challenges of using TEP as a nonflammable electrolyte for safe operations of Li electrodes.

Next, O₂ was introduced to the system and observed dramatic improvements. As shown in FIG. 1a, the first difference noticed was the appearance of a new, broad reduction peak at ca. 1.8 V in the Li∥Cu cell in the presence of O₂. Presumably, this peak corresponded to the reduction of O₂. While the other reduction features of the first scan were similar to those without O₂, the oxidation peak was indeed more pronounced upon the first reverse scan, reporting a greater recovery of plated Li (ca. 68%) when tested in O₂ than without O₂ (ca. 55%). The most striking difference, however, was how the cell behaved upon repeated CV scans. The Li stripping and plating features were by and large preserved at the 5^{th} cycle (FIG. 1b), although the broad peak corresponding to O₂ reduction was now absent. Arguably, the Li stripping peak appeared to be enhanced in comparison to that in the first cycle. These observations led us to conclude that the initial (electrochemical) reactions on the surface of Cu working electrode in O₂-containing TEP electrolyte have resulted in an SEI that favors subsequent Li stripping and plating. To further test this understanding, we next performed cycling tests in a symmetric Li∥Li cell. At a current density of 0.5 mA−cm⁻², no apparent increase of the overpotentials (<120 mV) for both stripping and plating of Li was observed after 300 cycles (FIG. 1c), at which point the experiment was artificially terminated. Similar results were reproduced for two more times. The excellent cycling performance in nonflammable electrolytes is comparable to the best reported results using approaches such as high-concentration electrolytes or with nitrate salt additives (25, 26).

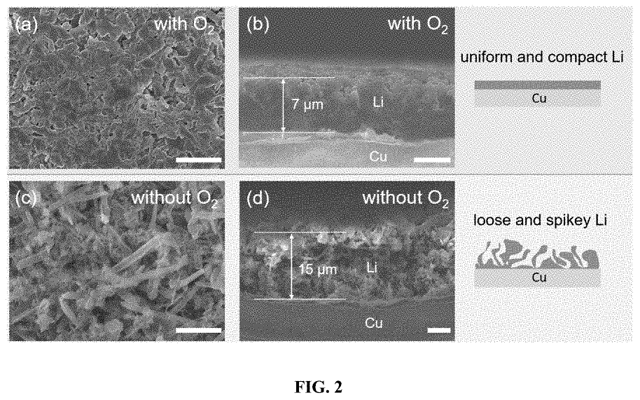

How the simple addition of O₂ greatly improves the Li striping and platting behaviors in TEP-based electrolyte is not only exciting but also intriguing. To understand the results, we examined the structure of the Cu electrode after the initial plating of Li by scanning electron microscope (SEM). As shown in FIG. 2, with the presence of O₂, a relatively uniform and compact layer of Li with granular microstructures was observed. The grain size was up to 5 μm in diameters. Such morphology resembles those reported in the literature when high-concentration electrolytes were used (25, 29). Recent studies have alluded that a desired structure of electrochemically plated Li should retain an even microstructure with large granular sizes and minimum tortuosity; otherwise the loss of “dead” Li would be significant and, hence, low Coulombic Efficiencies (CE) (30). That we observed such structures by simply adding O₂ to the TEP electrolyte is highly encouraging. In stark contrast, a layer of loose and spikey Li was observed in TEP without O₂, which are typical for Li plating without proper protections of an SEI. Inspired by the prior reports, we hypothesize that the introduction of O₂ has dramatically changed the SEI formation in TEP.

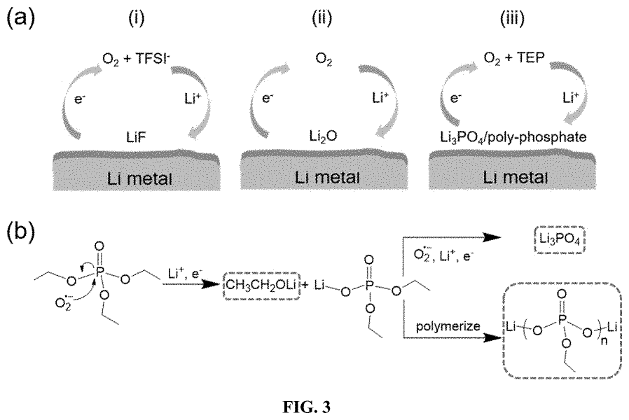

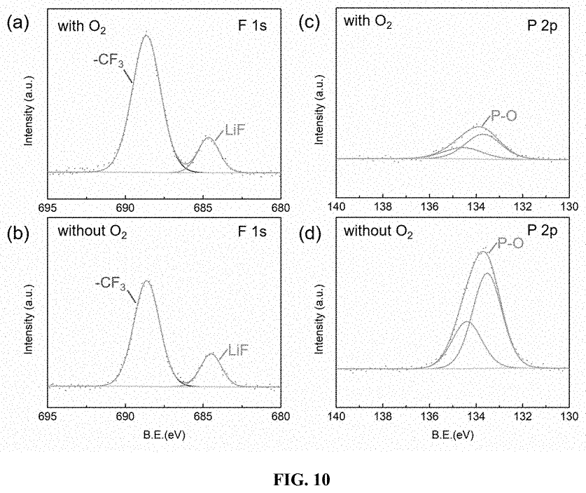

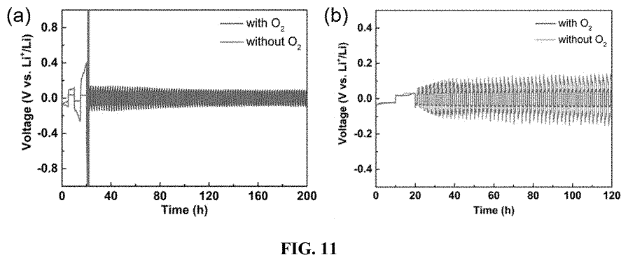

As shown in FIG. 3a, the presence of O₂ may lead to at least 3 possible reactions on the anode surface: (i) promoted decomposition of TFSI⁻ anions by reduced O₂; (ii) formation of Li₂O on the anode surface; and (iii) electrochemically-induced chemical reactions between TEP solvent and reactive O₂ species. These considerations are made with the assumption that electrochemical reduction of O₂ precedes these surface chemical reactions, which is supported by the broad O₂ reduction peak in the CV scan (FIG. 1a). Next, we examined the first possibility that concerns anion decomposition. Recently, there has been a surge of publications on using high-concentration electrolytes, especially FSI⁻/TFSI⁻-containing ones, to enable reversible Li metal stripping/plating (25, 31, 32). These approaches are based on the premise that the electrolyte decomposition could produce LiF-rich SEIs that are beneficial for Li stripping/plating. To measure the compositions of the SEI, we collected X-ray photoelectron spectra (XPS) on the Cu working electrode after Li plating. No measurable increase of LiF contents was observed (FIG. 10). Given that the TFSI⁻ concentration is relatively low (1 M), the first possibility of TFSI⁻ decomposition as the main reason for the dramatic increase of the cycling performance is highly unlikely. To further support this conclusion, we conducted similar cycling experiments as those shown in FIG. 1c but with 1 M LiClO₄ (in TEP) as the support electrolyte and observed similar results (FIG. 11a). Taken together, the evidence clearly ruled out the first possibility as shown in FIG. 3a.

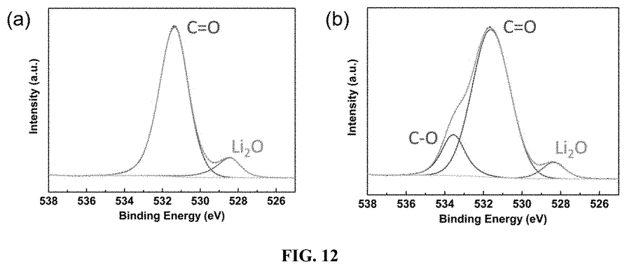

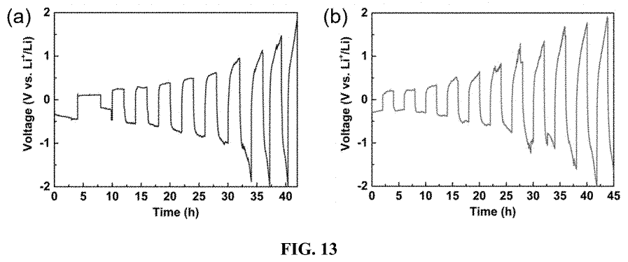

The second possibility of Li₂O formation on the anode was next considered. Given the presence of O₂ and the low electrochemical potentials of Li oxidation, it is conceivable that Li₂O may form on the anode. Recent studies have shown that Li₂O could play a positive role as a component in the SEI (33, 34). To test this possibility, we carried out control experiments to pre-form Li₂O via treating Li foil with dry O₂. XPS studies confirmed that this treatment indeed increased O content on the surface (FIG. 12a). Afterwards, the treated Li foil was used as the working electrode in a symmetric Li∥Li cell for cycling test. Without O₂ in the TEP electrolyte, the cell failed within 6 cycles (FIG. 13a). This set of experiments suggest that ex situ formed Li₂O does not enable Li stripping/plating in TEP. One may argue that in situ formed Li₂O by electrochemistry is necessary for the purpose. To address this concern, we employed the second method of promoting Li₂O formation in a cell in an ether-based electrolyte (1M LiTFSI in tetraethylene glycol dimethyl ether (TEGDME)). After 5 cycles of repeated stripping and plating, a Li₂O-rich SEI was confirmed by XPS on Li surface (FIG. 12b). The Li foil was then removed from the first cell and washed with 1,2-dimethoxyethane (DME). A new test cell was assembled with TEP as the support electrolyte. Without O₂, the cell failed quickly after 7 cycles, too (FIG. 13b). Taken together, we concluded that the reaction between O₂ and Li cannot account for the observed improvement.

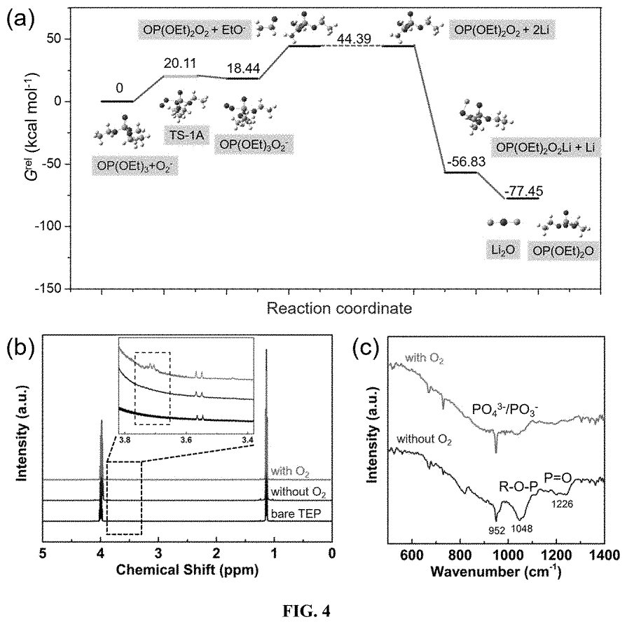

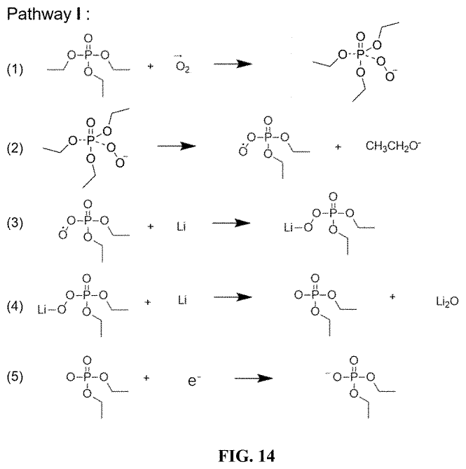

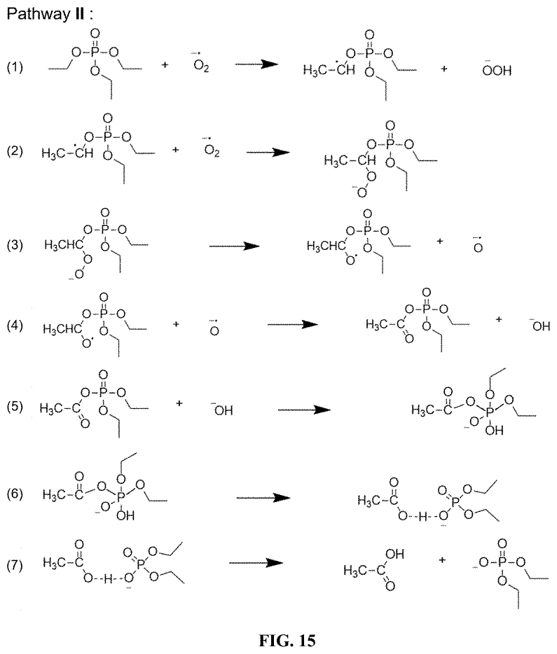

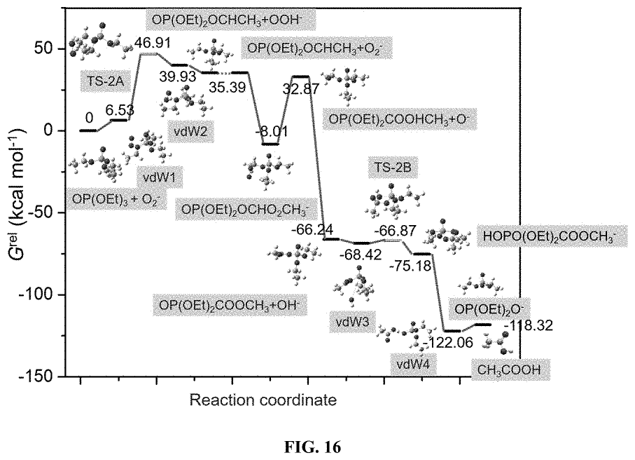

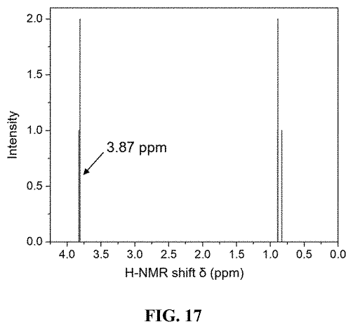

With the first two possibilities excluded, we are now guided to understand the improvement as a result of the unique reactions between TEP solvent and reactive O₂ species under electrochemical conditions. Close examinations of FIG. 1a reveal that O₂ is reduced at potentials <2.2 V during the first cycle. As the most likely species of the first electron transfer during oxygen reduction reaction (ORR) in an aprotic electrolyte, O₂^{•-} is a nucleophile (35). It can substitute the ethoxy group of TEP via the SN2 mechanism or abstract the neighboring hydrogen atom, as has been reported in the literature (36, 37). Subsequent electron transfer and O—O bond dissociation are expected to lead to the production of Li₃PO₄ or other poly-phosphate products. The two hypothesized reaction pathways are illustrated schematically in FIG. 3b and FIGS. 14-15. We first took advantage of theoretical calculation method to investigate the two possible reaction pathways. DFT calculation results suggest that both reaction pathways are thermodynamically favorable. For Pathway I, it was found that the initial reactions actually would follow the addition-elimination mechanism rather than direct SN2 substitution. This preference of the addition-elimination mechanism over the direct SN2 mechanism has been proposed and tested experimentally for trivalent phosphorus before (38). The rate-limiting step (RLS) of Pathway I is the leaving of the ethoxide groups (FIG. 4a and Table 1). For Pathway II, it was found that the RLS could be the abstracting of H atom or cleavage of O—O bond, both of which feature energy barriers nearly twice as high as those in Pathway I (FIG. 16 and Table 2). If these mechanisms held true, we would expect the release of Li ethoxide (CH₃CH₂OLi) as a by-product of Pathway I or the formation of Li acetate (CH₃COOLi) from Pathway II. Indeed, ¹H nuclear magnetic resonance (NMR) spectra clearly confirmed this expectation. By analyzing the electrolyte solutions after cycling in Li∥Li cells, we identified the peak at 3.71 ppm chemical shift to correspond to H in CH₃—CH₂—O—Li (FIG. 4b) (39). The experimental evidence supports that Pathway I is more likely, consistent with the understanding inferred from DFT calculations. It is worth noting that we also calculated the NMR chemical shifts of CH₃CH₂OLi, and the result was in good agreement of our measured values (FIG. 17). We next studied the SEI by Fourier-transform infrared spectroscopy (FTIR). It is observed in FIG. 4c that the introduction of O₂ clearly suppressed the formation of chemicals that give rise to IR peaks at 1048 and 1226 cm⁻¹. According to the literature (40-42), they correspond to the stretching of ester group (P—O—R) and P═O, respectively, in organo-phosphorous species. The distinct peak at 952 cm⁻¹ reports on the P—O stretching in orthophosphates (PO₄³⁻) or metaphosphates (PO₃⁻). This set of data suggests that direct TEP decomposition produces organo-phosphorous species; the introduction of O₂ alters the reaction pathways to promote the formation of phosphates.

TABLE 1
The reaction energetics for the hypothetical Pathway I computed by the
M06-2X functional. For each elementary step listed in the table, ΔG is
the free-energy change for the reaction, ΔG^{‡} is the free-energy barrier,
ΔH is the enthalpy change for the reaction, and ΔH^{‡} is the enthalpy
barrier for the reaction.

| Elementary Steps | ΔG (kcal mol⁻¹) | | ΔH (kcal mol⁻¹) | |
|---|---|---|---|---|
| OP(OEt)₃ + O₂⁻ → OP(OEt)₃O₂⁻ | ΔG₁ = | 18.44 | ΔH₁ = | 8.88 |
| | ΔG₁^{‡} = | 20.11 | ΔH₁^{‡} = | 10.60 |
| OP(OEt)₃O₂⁻ → OP(OEt)₂O₂ + | ΔG₂ = | 25.95 | ΔH₂ = | 36.60 |
| EtO⁻ | | | | |
| OP(OEt)₂O₂ + Li → OP(OEt)₂O₂Li | ΔG₃ = | −101.23 | ΔH₃ = | −108.44 |
| OP(OEt)₂O₂Li + Li → | ΔG₄ = | −20.62 | ΔH₄ = | −18.23 |
| OP(OEt)₂O + Li₂O | | | | |
| OP(OEt)₂O + e⁻ → OP(OEt)₂O⁻ | ΔG₅ = | −139.74 | ΔH₅ = | −140.71 |

TABLE 2
The reaction energetics for the hypothetical Pathway II computed by the
M06-2X functional. For each elementary step listed in the table, ΔG is
the free-energy change for the reaction, ΔG^{‡} is the free-energy barrier
(with respect to the pre-reaction vdW complex), ΔH is the enthalpy
change for the reaction, and ΔH^{‡} is the enthalpy barrier for the
reaction (with respect to the pre-reaction vdW complex).

| Elementary Steps | ΔG (kcal mol⁻¹) | | ΔH (kcal mol⁻¹) | |
|---|---|---|---|---|
| OP(OEt)₃ + O₂⁻ → OP(OEt)₂OCHCH₃ + OOH⁻ | ΔG₁ = | 35.39 | ΔH₁ = | 36.40 |
| | ΔG₁^{‡} = | 40.37 | ΔH₁^{‡} = | 37.32 |
| OP(OEt)₂OCHCH₃ + O₂⁻ → OP(OEt)₂OCHO₂CH₃⁻ | ΔG₂ = | −43.40 | ΔH₂ = | −54.47 |
| OP(OEt)₂OCHO₂CH₃⁻ → OP(OEt)₂OCOOHCH₃ + O⁻ | ΔG₃ = | 40.88 | ΔH₃ = | 49.27 |
| OP(OEt)₂COOHCH₃ + O⁻ → OP(OEt)₂COOCH₃ + OH⁻ | ΔG₄ = | −99.12 | ΔH₄ = | −108.01 |
| OP(OEt)₂COOCH₃ + OH⁻ → HOPO(OEt)₂COOCH₃⁻ | ΔG₅ = | −8.93 | ΔH₅ = | −8.08 |
| | ΔG₅^{‡} = | 1.55 | ΔH₅^{‡} = | −1.40 |
| HOPO(OEt)₂COOCH₃⁻ → CHCOO⁻ . . . HOPO(OEt)₂ → | ΔG₆ = | −46.88 | ΔH₆ = | −46.88 |
| CH₃COOH . . . ⁻OPO(OEt)₂ | (combined) | | (combined) | |
| CH₃COOH . . . OPO(OEt)₂ → CH₃COOH + OP(OEt)₂O⁻ | ΔG₇ = | 3.75 | ΔH₇ = | 12.62 |

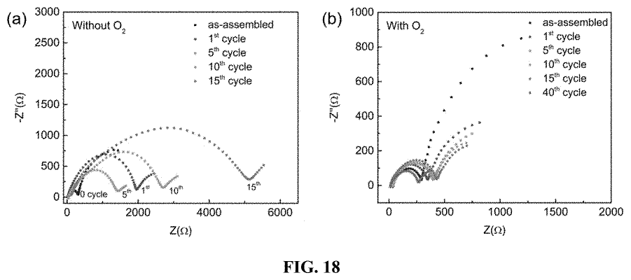

It has been reported that Li-conducting Li₃PO₄ SEI layer with a high Young's modulus can effectively suppress side reactions between Li and the electrolyte and thus limit Li dendrite growth (43, 44). Moreover, a layer of cross-linked poly-phosphates is expected to prevent direct decomposition of TEP and buffer the volume change during Li stripping/plating, in a similar fashion how poly-carbonates in the SEI enable the operation of graphite electrode (45, 46). We are, therefore, inspired to understand the effects as follows. Electrochemically reduced O₂ leads to the unique decomposition of TEP to yield a thin layer of SEI rich in Li phosphate and poly-phosphates. Such an SEI exhibits desired electrical and mechanical properties to regulate Li plating. The net result is that the plated Li is dense and free of dendrites. The stark difference of the plated Li for TEP with and without O₂ (FIG. 2) strongly supports this hypothesis. To further validate the conjecture, we performed electrochemical characterization by electrochemical impedance spectroscopy (EIS). Here, a Li∥Li cell was examined as a function of the cycling history. It is seen in FIG. 18 that the initial charge transfer resistance was similar for cells with or without O₂ (ca. 300 Ω). After only 1 cycle of Li stripping/plating, the resistance increased dramatically (to ca. 1,900 Ω) for the cell without O₂; in stark contrast, that for the cell with O₂ did not change significantly. The comparison highlights that direct decomposition of TEP under electrochemical conditions is highly detrimental to Li stripping/plating, consistent with prior reports that organolithium compounds (e.g. lithiated phosphates) and inorganic lithium salts (e.g. LiOH) are poor Li⁺ conductors (22, 47). In fact, the measured resistance would increase to ca. 2,700 Ω after 10 cycles for a cell without O₂, making it not meaningful to further characterize the cell. The increase of the charge transfer resistance as measured by EIS agrees with the rapid rise of the overpotentials as shown in FIG. 1c. By comparison, repeated stripping/plating of Li in TEP with O₂ gradually decreased the charge transfer resistance to ca. 250 Ω after 40 cycles. Of course, we are mindful that the resistance is still too high for practical applications, and further research will be needed to further reduce the contact resistance. The results are encouraging, nonetheless, as they are comparable with other literature reports studying Li metal as an anode, particularly in nonflammable phosphate electrolytes (29, 48). Most encouragingly, the nature of the reaction is such that the resistance actually decreases over cycling, strongly suggesting that a favorable SEI is formed, as is true in other functional SEI formation processes. To the best of our knowledge, this is the first time that a unique electrochemically-induced electrolyte decomposition pathway is proposed. The mechanism not only enriches the knowledge on the complex reactions that enable the formation of a “good” SEI, but also serves as a facile approach to enable the utilization of an otherwise difficult to implement electrolyte. Next, we explored the utility of the as-formed SEI in protecting Li metal as an anode in Li—O₂ and Li-ion batteries.

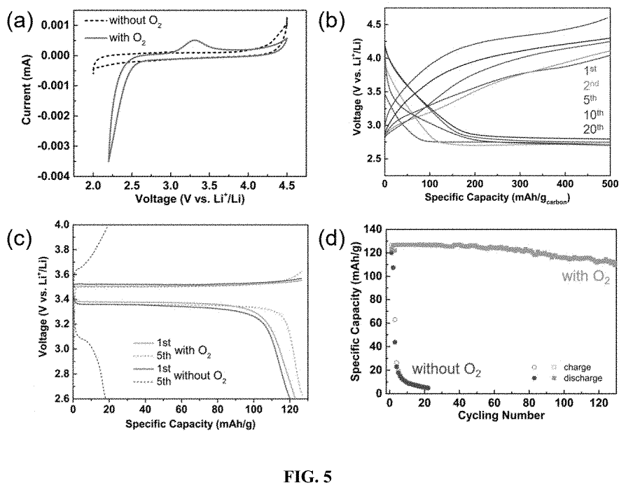

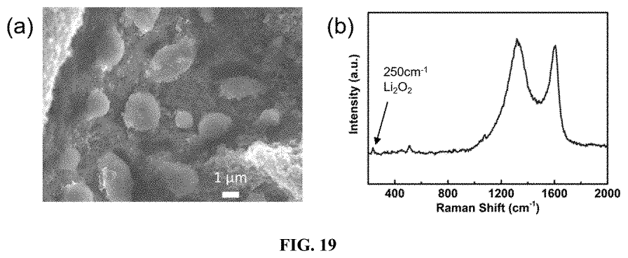

Given the involvement of O₂ in the above-identified processes, the first prototypical battery we sought to test was Li—O₂ batteries with TEP as an electrolyte. Due to the poor performance of the anode, earlier attempts toward this end have concluded that organic phosphate-based electrolyte was not compatible with Li—O₂ batteries (37, 49). To prove that the system indeed works, we first studied the electrochemical behaviors of the system in a three-electrode configuration, where glassy carbon was used as the working electrode, and two Li ribbons were used as the counter and reference electrodes. As shown in FIG. 5a, the reduction wave took off at ca. 2.6 V, corresponding to the O₂→Li₂O₂ reaction; on the reverse scan, the oxidation wave was observed starting from ca. 3.0 V, corresponding to the O₂ evolution reaction. The redox features in TEP electrolyte resembled those in ether-based electrolytes, which are well established for Li—O₂ battery operations (50, 51). Importantly, these electrochemical features were absent without O₂, strongly suggesting that they report on reversible O₂ reduction and evolution in a TEP electrolyte, which is desired but has not been reported previously. Then we fabricated a Li—O₂ full cell for galvanostatic tests. Three dimensionally ordered mesoporous carbon (3DOm) was used as the cathode to take advantage of its good performance for such applications, especially its stability against oxidation (52). As shown FIG. 5b, more than 20 cycles of discharge and recharge were achieved at a current density of 100 mA/g_{carbon} in TEP electrolyte with the charge potential cut-off as 4.5 V. The cycling performance is comparable to that in the more popularly studied 1,2-dimethoxyethane (DME) electrolyte under similar test conditions (52). To confirm that the electrochemical features indeed report on the formation and decomposition of Li₂O₂ as the main discharge product, the morphology of deep-discharged cathode was studied by SEM. FIG. 19a shows that a representative toroidal structure was observed, consistent with literature reports where fast kinetics favors toroid formation (53). The Raman spectra in FIG. 19b also proved Li₂O₂ as the discharge product (54). It is worth highlighting that the results were obtained by using Li metal as the anode without special protections. This is the first time that a nonflammable phosphate electrolyte is demonstrated for the operation of Li—O₂ batteries. It opens up the door to constructing safe Li—O₂ batteries that could offer high energy densities to fully actualize the potentials held by this new chemistry.

With exciting results on Li—O₂ batteries established, we next tested whether the same strategy works for Li-ion batteries. For this purpose, a full battery consisting of LiFePO₄ (LFP) as the cathode and a Li metal as the anode was fabricated. Stark differences were readily observed in the voltage-capacity profiles as shown in FIG. 5c with and without O₂. The presence of O₂ promoted the formation of functional SEI on the Li anode and established stable charge and discharge plateaus at 3.50 V and 3.35 V, respectively (55). In contrast, no stable charge/discharge plateau was observed in the cell without O₂ after 5 cycles, which quickly worsened even further afterwards because of the increasing overpotential on the Li anode side. Subsequent cycling tests of the cell (FIG. 5d) exhibits more than 130 reversible cycles with capacity retention of 82% by introducing O₂ as additives. While the cell without O₂ exhibits very low efficiency and capacity because TEP is incompatible to Li metal anode. These experiments further demonstrate that our strategy can be utilized to promote the development of Li metal anode in Li-ion batteries and make nonflammable TEP electrolyte as a promising candidate.

In one aspect, the present invention provides a battery cell, comprising an anode, a cathode, a nonflammable electrolyte, a separator configured to separate the anode and the cathode and permit lithium ion permeability there-through, and a solid-electrolyte interphase (SEI) layer on the surface of the anode or the cathode. In some embodiments, the battery cell is safe and has high-capacity. In some embodiments, the battery cell is resistant to fire. In some embodiments, the battery cell comprises fire retardant.

In some embodiments, the anode comprises lithium. In some embodiments, the cathode comprises LiFePO₄ (LFP). In some embodiments, the cathode comprises lithium. In some embodiments, the cathode comprises copper.

In some embodiments, the nonflammable electrolyte comprises triethyl phosphate (TEP). In some embodiments, the nonflammable electrolyte comprises a fire retardant.

In some embodiments, the SEI layer comprises Li₃PO₄.

In some embodiments, the SEI layer comprises poly-phosphate.

In some embodiments, the SEI layer comprises Li₃PO₄ and poly-phosphate.

In some embodiments, the SEI layer is formed by exposing the battery cell to O₂.

In some embodiments, the battery cell is purged with O₂.

In some embodiments, the continuous exposure to O₂ is not required for making the safe high capacity battery described herein.

In some embodiments, the SEI layer is formed by electrochemical reduction reaction.

In some embodiments, the thickness of the SEI layer is in a range of about 0.05 μm to about 50 μm. In some embodiments, the thickness of the SEI layer is in a range of about 0.05 μm to about 10 μm, about 0.1 μm to about 10 μm, about 1 μm to about 10 μm, about 5 μm to about 20 μm, about 10 μm to about 40 μm, about 20 μm to about 40 μm, about 30 μm to about 50 μm, about 50 μm to about 100 μm, about 100 μm to about 400 μm, about 100 μm to about 500 μm, or about 0.05 μm to about 500 μm.

In some embodiments, the thickness of the SEI layer is about 0.05 μm, about 0.1 μm, about 0.2 μm, about 0.3 μm, about 0.4 μm, about 0.5 μm, about 0.6 μm, about 0.7 μm, about 0.8 μm, about 0.9 μm, about 1 μm, about 5 μm, about 15 μm, about 20 μm, about 25 μm, about 30 μm, about 35 μm, about 40 μm, about 45 μm, about 55 μm, or about 60 μm.

In some embodiments, the SEI layer is formed during a battery cell charge cycle. In some embodiments, the SEI layer is formed during a battery cell discharge cycle.

In some embodiments, the SEI layer is stable. In some embodiments, the SEI layer on the surface of the anode is stable to protect the anode. In some embodiments, the SEI layer on the surface of the cathode is stable to protect the cathode. In some embodiments, the SEI layer does not decompose over time. In some embodiments, the SEI layer enhances lithium stripping and plating.

In some embodiments, the lithium stripping and plating is reversible.

In some embodiments, the battery cell has Coulombic Efficiency (CE) selected from the group consisting of 95%, 95.1%, 95.2%, 95.3%, 95.4%, 95.5%, 95.6%, 95.7%, 95.8%, 95.9%, 96%, 96.1%, 96.2%, 96.3%, 96.4%, 96.5%, 96.6%, 96.7%, 96.8%, 96.9%, 97%, 97.1%, 97.2%, 97.3%, 97.4%, 97.5%, 97.6%, 97.7%, 97.8%, 97.9%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8%, 99.9%, and 100%.

In some embodiments, the battery cell has higher Coulombic Efficiency (CE) than the corresponding battery cell without exposing to O₂.

In some embodiments, the battery cell is capable of achieving at least 5,000 charging and discharging cycles with at least 70% capacity retention. In some embodiments, the battery cell is capable of achieving at least 6,000 charging and discharging cycles with at least 70% capacity retention. In some embodiments, the battery cell is capable of achieving at least 7,000 charging and discharging cycles with at least 70% capacity retention. In some embodiments, the battery cell is capable of achieving at least 8,000 charging and discharging cycles with at least 70% capacity retention. In some embodiments, the battery cell is capable of achieving at least 9,000 charging and discharging cycles with at least 70% capacity retention. In some embodiments, the battery cell is capable of achieving at least 10,000 charging and discharging cycles with at least 70% capacity retention.

In some embodiments, the battery cell has higher number of charging and discharging cycles with at least 70% capacity retention than the corresponding battery cell without exposing to O₂.

In another aspect, the present invention provides a method of making a safe high capacity battery cell comprising a step of exposing the battery cell to O₂. In some embodiments, the present invention provides a method of making a fire-resistant battery cell comprising a step of exposing the battery cell to O₂. Lithium metal anode holds great promises for next-generation battery technologies but is notoriously difficult to work with. The key to solving this challenge is believed to lie in the ability of forming stable solid-electrolyte interphase (SEI) layers. To further address potential safety issues, it is critical to achieve this goal in nonflammable electrolytes. Reversible Li plating/striping could be realized in triethyl phosphate (TEP), a known flame retardant. The critical enabling factor of our approach was the introduction of oxygen, which upon electrochemical reduction induces the initial decomposition of TEP and produces Li₃PO₄ and poly-phosphate. Importantly, the reaction was self-limiting, and the resulting material regulated Li plating by limiting dendrite formation.

The method described herein possesses advantages over the method without exposure to oxygen. The battery cell produced by the method described herein is safe and has high capacity. Since the battery cell described herein comprises nonflammable electrolytes, the battery cell is fire resistant. Further, the battery cell described herein has higher Coulombic Efficiency (CE) than the corresponding battery cell without exposing to O₂. Also, the battery cell described herein has higher number of charging and discharging cycles with at least 70% capacity retention than the corresponding battery cell without exposing to O₂.

### EXAMPLES

The following examples are offered to illustrate, but not to limit the invention. While exemplary embodiments have been shown and described below, it will be apparent to those skilled in the art that modifications and variations could be made without departing from the scope of the present disclosure as defined by the appended claims.

### Electrochemical Measurements

All battery cycling tests were carried out using customized Swagelok™ type cells. Li foils (Sigma-Aldrich) were used as counter/reference electrodes. Li foils or Cu foils (MTI) were used as working electrodes in Li∥Li cell or Li∥Cu cell. Celgard 2400 films were used as the separator. 150 μL 1M LiTFSI in TEP was used as the electrolyte for battery tests. TEP (≥99.8%, Sigma-Aldrich) was stored over freshly activated 4 Å molecular sieves for two days before usage. LiTFSI (99.95%, Sigma-Aldrich) was baked at 90° C. in a vacuum oven within the glove box and mixed with TEP to prepare the 1 M electrolyte solution. To introduce O₂ atmosphere, the headspace of as-fabricated cells was purged with O₂ in an O₂-tolerated Ar-filled glovebox (MBRAUN, H₂O<0.1 ppm). For cathode used in Li—O₂ cell test, 3DOm carbon and polytetrafluoroethylene (PTFE) were mixed in isopropyl alcohol (IPA) with a mass ratio of 95:5. The mixture was dispersed by sonication and then coated on the carbon paper (Toray 120, Fuel Cell Store). The electrode was further dried in vacuum oven overnight at 60° C. to remove the residual solvent. Commercial LiFePO₄ cathode (single side active material density: 120 g/m², MTI) was directly used for Li-ion cell test. For CV measurements of Li—O₂ cell, two Li ribbons were used as the counter and reference electrode, respectively. Glassy carbon (3 mm diameter) was applied as the working electrode. EIS was conducted using a Modulab XM potentiostat at the open-circuit voltage with the frequency range of 1 MHz-0.1 Hz and an AC amplitude of 10 mV.

### Materials Characterizations

SEM was conducted with a JEOL 6340F microscope operated at a 10 kV accelerating voltage. NMR spectra were recorded at ambient temperature on spectrometers operating at 500 or 600 MHz for 1H NMR. FTIR was performed with a Bruker ALPHA FTIR spectrometer in a N₂-filled glovebox. Raman spectra were acquired with a micro-Raman system (XploRA, Horiba) with 532 nm laser excitation. XPS was carried out on a K-Alpha+XPS (Thermo Scientific) with an Al X-ray source. After battery cycling, the cell was dissembled in an O₂-tolerant Ar-filled glovebox (MBRAUN, H₂O<0.1 ppm). The electrode samples were washed with DME to remove residue salts, and then dried under a vacuum at room temperature for SEM, FTIR, Raman and XPS characterizations. Electrolytes were mixed with benzene-d6 to generate NMR samples. All 1H NMR chemical shifts were reported in ppm in relation to the benzene-d6 peak at 7.160 ppm.

### Calculation Methods

The geometry optimizations, vibrational analysis, and the transition-state searches were carried out by M06-2X functional (1) with 6-311+G** basis (2, 3) in Gaussian 09 program (4). The free energies are computed at 300K, with a frequency scale factor of 0.97 (5), which approximately corrects for the vibrational anharmonicity and systematic errors in the electronic structure method. The solvation free energies are included in the reported relative free energy G^{rel}with tributyl-phosphate (TBP) as the solvent by using the implicit SMD solvation model (6). TBP was used as an approximation for triethyl phosphate (TEP) which is the actual solvent used in the experiments.

The relative free energy (in kcal·mol⁻¹) of a point X, G_{X}^{rel}, in the solution-phase free-energy diagram is computed as:

G_{X}^{rel}=G_{X}−G_{X-1}+[ΔG_{S}^{*→O}(X)−ΔG_{S}^{*→O}(X−1)]+G_{X-1}^{rel}

where G_{X} is the Gibbs free energy of the species (for a transition-state structure or a vdW complex) or the summation of the Gibbs free energies of the species at the point X; G_{X-1} is for the previous point (i.e., X−1), and G_{X-1}^{rel} is the relative free energy at this point. ΔG_{S}^{*→O} is the free-energy correction for converting the thermodynamic standard states: if the solvent (TEP) serves as a reactant, ΔG_{S}^{*→O}=1.06 kcal−mol⁻¹; for a solute in the solvent (with the standard-state concentration 1 mol L⁻¹), ΔG_{S}^{*→O}=1.90 kcal·mol⁻¹ (7).

For clarity, we divided each free-energy diagram into two parts. For the first part in Pathway I, G_{X}^{rel} of the starting point, i.e., G_{OP(OEt)}_{₃}_{+O}_{₂}₋+ΔG_{S}^{*→O}(OP(OEt)₃+O₂⁻), is set as zero, and for the second part (which is connected with the first part with a dotted line), the relative free energy of the new starting point (i.e., OP(OEt)₂O₂+Li), is set as 44.39 kcal·mol⁻¹. Similarly, in Pathway II, G_{X}^{rel} of the starting point for the first part is set to be zero, and for the second part, the relative free energy of the new starting point (i.e., OP(OEt)₂OCHCH₃+O₂⁻) is set as 32.87 kcal−mol⁻¹.

All the reaction intermediates were verified to be local minima with no imaginary frequency, and for a transition state, it has one imaginary-frequency mode. The relative free energy of the first transition-state structure (TS-2A) in Pathway I was obtained using the separable equilibrium solvation (SES) approximation (8, 9), because we could not locate the first-order saddle point directly with the implicit SMD solvation model. In the SES approximation, the solvation effect is treated by performing the single-point energy calculations with the SMD solvation model based on the gas-phase optimized geometries. The solution-phase free-energy barrier (for TS-2A only) is computed as ΔG^{‡}=ΔG^{‡}(gas-phase)+[ΔE^{‡}(SMD, single-point)−ΔE^{‡}(gas-phase)], where ΔG^{‡}(gas-phase) is the gas-phase free-energy barrier, ΔE^{‡}(SMD, single-point) is the single-point SMD electronic-structure energy (i.e., the SCF energy computed with the SMD model) difference between the gas-phase optimized TS-2A and the pre-reaction vdW complex, ΔE^{‡}(gas-phase) is the electronic-structure energy (without the SMD model) difference between the gas-phase optimized TS-2A and pre-reaction vdW complex. NMR computation of CH₃CH₂OLi was performed with respect to Tetramethylsilane (TMS) by M06-2X/6-311+G^{**} using the gauge-independent atomic orbital (GIAO) method (10).

### References

1. D. H. Doughty, E. P. Roth, A General Discussion of Li Ion Battery Safety. Electrochem. Soc. Interface 21, 37 (2012).

2. K. Liu, Y. Liu, D. Lin, A. Pei, Y. Cui, Materials for lithium-ion battery safety. Sci. Adv. 4, eaas9820 (2018).

3. C. Uhlmann, J. Illig, M. Ender, R. Schuster, E. Ivers-Tiffée, In situ detection of lithium metal plating on graphite in experimental cells. J. Power Sources 279, 428-438 (2015).

4. T. Waldmann, B. -I. Hogg, M. Wohlfahrt-Mehrens, Li plating as unwanted side reaction in commercial Li-ion cells—A review. J. Power Sources 384, 107-124 (2018).

5. E. J. McShane, et al., Quantification of Inactive Lithium and Solid-Electrolyte Interphase Species on Graphite Electrodes after Fast Charging. ACS Energy Lett. 5, 2045-2051 (2020).

6. S. J. An, et al., The state of understanding of the lithium-ion-battery graphite solid electrolyte interphase (SEI) and its relationship to formation cycling. Carbon 105, 52-76 (2016).

7. X. -B. Cheng, R. Zhang, C. -Z. Zhao, Q. Zhang, Toward Safe Lithium Metal Anode in Rechargeable Batteries: A Review. Chem. Rev. 117, 10403-10473 (2017).

8. D. Aurbach, et al., The Study of Electrolyte Solutions Based on Ethylene and Diethyl Carbonates for Rechargeable Li Batteries: I . Li Metal Anodes. J. Electrochem. Soc. 142, 2873 (1995).

9. D. Aurbach, B. Markovsky, A. Shechter, Y. Ein-Eli, H. Cohen, A Comparative Study of Synthetic Graphite and Li Electrodes in Electrolyte Solutions Based on Ethylene Carbonate-Dimethyl Carbonate Mixtures. J. Electrochem. Soc. 143, 3809 (1996).

10. Y. Zhang, Y. Zhong, Q. Shi, S. Liang, H. Wang, Cycling and Failing of Lithium Metal Anodes in Carbonate Electrolyte. J. Phys. Chem. C 122, 21462-21467 (2018).

11. D. Lin, Y. Liu, Y. Cui, Reviving the lithium metal anode for high-energy batteries. Nat. Nanotechnol. 12, 194-206 (2017).

12. B. Liu, J. -G. Zhang, W. Xu, Advancing Lithium Metal Batteries. Joule 2, 833-845 (2018).

13. C. Fang, X. Wang, Y. S. Meng, Key Issues Hindering a Practical Lithium-Metal Anode. Trends Chem. 1, 152-158 (2019).

14. T. Li, X. -Q. Zhang, P. Shi, Q. Zhang, Fluorinated Solid-Electrolyte Interphase in High-Voltage Lithium Metal Batteries. Joule 0 (2019).

15. Y. Liu, et al., Solubility-mediated sustained release enabling nitrate additive in carbonate electrolytes for stable lithium metal anode. Nat. Commun. 9, 3656 (2018).

16. C. Yan, et al., Lithium Nitrate Solvation Chemistry in Carbonate Electrolyte Sustains High-Voltage Lithium Metal Batteries. Angew. Chem., Int. Ed. 57, 14055-14059 (2018).

17. Y. Gao, et al., Polymer-inorganic solid-electrolyte interphase for stable lithium metal batteries under lean electrolyte conditions. Nat. Mater. 18, 384-389 (2019).

18. X. Fan, et al., Non-flammable electrolyte enables Li-metal batteries with aggressive cathode chemistries. Nat. Nanotechnol. 13, 715-722 (2018).

19. Z. Yu, et al., Molecular design for electrolyte solvents enabling energy-dense and long-cycling lithium metal batteries. Nat. Energy 5, 526-533 (2020).

20. X. Wang, E. Yasukawa, S. Kasuya, Nonflammable Trimethyl Phosphate Solvent-Containing Electrolytes for Lithium-Ion Batteries: I. Fundamental Properties. J. Electrochem. Soc. 148, A1058—A1065 (2001).

21. K. Xu, M. S. Ding, S. Zhang, J. L. Allen, T. R. Jow, Evaluation of Fluorinated Alkyl Phosphates as Flame Retardants in Electrolytes for Li-Ion Batteries: I. Physical and Electrochemical Properties. J. Electrochem. Soc. 150, A161-A169 (2003).

22. X. Wang, E. Yasukawa, S. Kasuya, Nonflammable Trimethyl Phosphate Solvent-Containing Electrolytes for Lithium-Ion Batteries: II. The Use of an Amorphous Carbon Anode. J. Electrochem. Soc. 148, A1066-A1071 (2001).

23. K. Xu, S. Zhang, J. L. Allen, T. R. Jow, Evaluation of Fluorinated Alkyl Phosphates as Flame Retardants in Electrolytes for Li-Ion Batteries: II. Performance in Cell. J. Electrochem. Soc. 150, A170-A175 (2003).

24. J. Wang, et al., Fire-extinguishing organic electrolytes for safe batteries. Nat. Energy 3, 22-29 (2018).

25. Z. Zeng, et al., Non-flammable electrolytes with high salt-to-solvent ratios for Li-ion and Li-metal batteries. Nat. Energy 3, 674-681 (2018).

26. S. -J. Tan, et al., Nitriding-Interface-Regulated Lithium Plating Enables Flame-Retardant Electrolytes for High-Voltage Lithium Metal Batteries. Angew. Chem., Int. Ed. 58, 7802-7807 (2019).

27. S. Chen, et al., High-Efficiency Lithium Metal Batteries with Fire-Retardant Electrolytes. Joule 2, 1548-1558 (2018).

28. T. Liu, et al., In situ quantification of interphasial chemistry in Li-ion battery. Nat. Nanotechnol. 14, 50-56 (2019).

29. L. Xiao, et al., Stable Li Metal Anode with “Ion-Solvent-Coordinated” Nonflammable Electrolyte for Safe Li Metal Batteries. ACS Energy Lett. 4, 483-488 (2019).

30. C. Fang, et al., Quantifying inactive lithium in lithium metal batteries. Nature 572, 511-515 (2019).

31. L. Suo, Y. -S. Hu, H. Li, M. Armand, L. Chen, A new class of Solvent-in-Salt electrolyte for high-energy rechargeable metallic lithium batteries. Nat. Commun. 4, 1481 (2013).

32. X. Fan, et al., Highly Fluorinated Interphases Enable High-Voltage Li-Metal Batteries. Chem 4, 174-185 (2018).

33. F. Qiu, et al., An ultra-stable and enhanced reversibility lithium metal anode with a sufficient O2 design for Li-O2 battery. Energy Storage Mater. 12, 176-182 (2018).

34. E. Wang, S. Dey, T. Liu, S. Menkin, C. P. Grey, Effects of Atmospheric Gases on Li Metal Cyclability and Solid-Electrolyte Interphase Formation. ACS Energy Lett. 5, 1088-1094 (2020).

35. X. Yao, Q. Dong, Q. Cheng, D. Wang, Why Do Lithium—Oxygen Batteries Fail: Parasitic Chemical Reactions and Their Synergistic Effect. Angew. Chem., Int. Ed. 55, 11344-11353 (2016).

36. D. C. Isbell, R. R. Dewald, Kinetic study of the reduction of trimethyl phosphate, triethyl phosphate, and tributyl phosphate by sodium in liquid ammonia. J. Phys. Chem. 91, 6695-6698 (1987).

37. Z. E. M. Reeve, A. D. Pauric, K. J. Harris, G. R. Goward, Evaluation of the Stability of Trimethyl Phosphate as a Li—O₂ Battery Electrolyte via Multinuclear Solid-State NMR. J. Phys. Chem. C 119, 26840-26848 (2015).

38. J. Li, P. Beak, Endocyclic restriction test: experimental evaluation of the transition structure geometry of a nucleophilic substitution at trivalent phosphorus. J. Am. Chem. Soc. 114, 9206-9207 (1992).

39. G. García-Herbosa, M. Aparicio, J. Mosa, J. V. Cuevas, T. Torroba, Choosing the best molecular precursor to prepare Li₄Ti₅O₁₂ by the sol-gel method using 1H NMR: evidence of [Ti₃(OEt)₁₃]—in solution. Dalton Trans. 45, 13888-13898 (2016).

40. L. Daasch, D. Smith, Infrared Spectra of Phosphorus Compounds. Anal. Chem. 23, 853-868 (1951).

41. L. Popović, D. de Waal, J. C. A. Boeyens, Correlation between Raman wavenumbers and P—O bond lengths in crystalline inorganic phosphates. J. Raman Spectrosc. 36, 2-11 (2005).

42. A. H. Ahmad, A. K. Arof, XRD, conductivity and FTIR studies on LiI—Li₂WO₄—Li₃PO₄ prepared by low temperature sintering. Ionics 10, 200-205 (2004).

43. N. -W. Li, Y. -X. Yin, C. -P. Yang, Y. -G. Guo, An Artificial Solid Electrolyte Interphase Layer for Stable Lithium Metal Anodes. Adv. Mater. 28, 1853-1858 (2016).

44. L. Wang, et al., Li metal coated with amorphous Li₃PO₄ via magnetron sputtering for stable and long-cycle life lithium metal batteries. J. Power Sources 342, 175-182 (2017).

45. C. C. Nguyen, B. L. Lucht, Comparative Study of Fluoroethylene Carbonate and Vinylene Carbonate for Silicon Anodes in Lithium Ion Batteries. J. Electrochem. Soc. 161, A1933 (2014).

46. M. Nie, et al., Effect of Vinylene Carbonate and Fluoroethylene Carbonate on SEI Formation on Graphitic Anodes in Li-Ion Batteries. J. Electrochem. Soc. 162, A7008 (2015).

47. N. Feng, P. He, H. Zhou, Critical Challenges in Rechargeable Aprotic Li—O₂ Batteries. Adv. Energy Mater. 6, 1502303 (2016).

48. Y. Dong, et al., Fire-Retardant Phosphate-Based Electrolytes for High-Performance Lithium Metal Batteries. ACS Appl. Energy Mater. 2, 2708-2716 (2019).

49. W. Xu, et al., The stability of organic solvents and carbon electrode in nonaqueous Li—O₂ batteries. J. Power Sources 215, 240-247 (2012).

50. Y. -C. Lu, et al., Lithium-oxygen batteries: bridging mechanistic understanding and battery performance. Energy Environ. Sci. 6, 750-768 (2013).

51. F. Li, et al., Ru/ITO: A Carbon-Free Cathode for Nonaqueous Li—O₂ Battery. Nano Lett. 13, 4702-4707 (2013).

52. J. Xie, et al., Three Dimensionally Ordered Mesoporous Carbon as a Stable, High-Performance Li—O₂ Battery Cathode. Angew. Chem., Int. Ed. 127, 4373-4377 (2015).

53. N. B. Aetukuri, et al., Solvating additives drive solution-mediated electrochemistry and enhance toroid growth in non-aqueous Li—O₂ batteries. Nature Chem. 7, 50-56 (2015).

54. D. Zhai, et al., Raman Evidence for Late Stage Disproportionation in a Li—O₂ Battery. J. Phys. Chem. Lett. 5, 2705-2710 (2014).

55. L.-X. Yuan, et al., Development and challenges of LiFePO₄ cathode material for lithium-ion batteries. Energy Environ. Sci. 4, 269-284 (2011).

1. A battery cell, comprising an anode, a cathode, a nonflammable electrolyte, a separator configured to separate the anode and the cathode and permit lithium ion permeability there-through, and a solid-electrolyte interphase (SEI) layer on the surface of the anode or the cathode.

2. The battery cell is fire-resistant.

3. The battery cell of claim 1, wherein the anode comprises lithium.

4. The battery cell of claim 1, wherein the cathode comprises LiFePO4 (LFP).

5. The battery cell of claim 1, wherein the nonflammable electrolyte comprises triethyl phosphate (TEP).

6. The battery cell of claim 1, wherein the SEI layer comprises Li₃PO₄.

7. The battery cell of claim 1, wherein the SEI layer comprises poly-phosphate.

8. The battery cell of claim 1, wherein the SEI layer comprises Li₃PO₄ and poly-phosphate.

9. The battery cell of claim 6, wherein the SEI layer is formed by exposing the battery cell to O₂.

10. The battery cell of claim 9, wherein the battery cell is purged with O₂.

11. The battery cell of claim 9, wherein the continuous exposure to O₂ is not required.

12. The battery cell of claim 9, wherein the SEI layer is formed by electrochemical reduction reaction.

13. The battery cell of claim 1, wherein the thickness of the SEI layer is in a range of about 0.05 μm to about 50 μm.

14. The battery cell of claim 9, wherein the SEI layer is formed during a battery cell charge cycle.

15. The battery cell of claim 1, wherein the SEI layer is stable.

16. The battery cell of claim 1, wherein the lithium stripping and plating is reversible.

17. The battery cell of claim 1, wherein the battery cell has Coulombic Efficiency (CE) selected from the group consisting of 95%, 95.1%, 95.2%, 95.3%, 95.4%, 95.5%, 95.6%, 95.7%, 95.8%, 95.9%, 96%, 96.1%, 96.2%, 96.3%, 96.4%, 96.5%, 96.6%, 96.7%, 96.8%, 96.9%, 97%, 97.1%, 97.2%, 97.3%, 97.4%, 97.5%, 97.6%, 97.7%, 97.8%, 97.9%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, 99.8%, 99.9%, and 100%.

18. The battery cell of claim 9, wherein the battery cell has higher Coulombic Efficiency (CE) than the corresponding battery cell without exposing to O₂.

19. The battery cell of claim 1, wherein the SEI layer enhances lithium stripping and plating.

20. The battery cell of claim 1, wherein the battery cell is capable of achieving at least 5,000 charging and discharging cycles with at least 70% capacity retention.

21. The battery cell of claim 9, wherein the battery cell has higher number of charging and discharging cycles with at least 70% capacity retention than the corresponding battery cell without exposing to O₂

22. A method of making a fire-resistant battery cell comprising a step of exposing the battery cell to O₂.

23. The method of claim 22, wherein the battery cell comprises an anode, a cathode, a nonflammable electrolyte, a separator configured to separate the anode and the cathode and permit lithium ion permeability there-through, and a solid-electrolyte interphase (SEI) layer on the surface of the anode or the cathode.

24. The method of claim 23, wherein the nonflammable electrolyte comprises triethyl phosphate (TEP).

25. The method of claim 23, wherein the SEI layer comprises Li₃PO₄.

26. The method of claim 23, wherein the SEI layer comprises poly-phosphate.

27. The method of claim 23, wherein Li₃PO₄ is formed through exposing the battery cell to O₂.

28. The method of claim 23, wherein poly-phosphate is formed through exposing the battery cell to O₂.

29. The method of claim 23, the SEI layer comprises Li₃PO₄ and poly-phosphate.

30. The method of claim 29, wherein the SEI layer is formed by exposing the battery cell to O₂.

31. The method of claim 22, wherein the battery cell is purged with O₂.

32. The method of claim 31, wherein the continuous exposure to O₂ is not required.
